(19) United States
(12) Patent Application Publication
(10) Pub. No.: US 2002/0139472 A1
(43) Pub. Date: Oct. 3, 2002

(54) Method of forming an electrical circuit on a substrate

(76) Inventor: Albert Wojewnik, Royal Oak, MI (US)

Correspondence Address: MACMILLAN, SOBANSKI & TODD, LLC, ONE MARITIME PLAZA-FOURTH FLOOR, 720 WATER STREET, TOLEDO, OH, 43604, US

(21) Appl. No.: 09/821,345

(22) Filed: Mar. 29, 2001

(51) Int. Cl. B32B 31/00

(52) U.S. Cl. 156/267; 156/289; 156/344

(57) ABSTRACT

A method of forming an electrical circuit on a surface of a substrate includes; placing a masking film against the surface of the substrate; subsequently removing portions of the masking film to expose selected portions of the surface of the substrate to define an electrical circuit path; and applying an electrically conductive material onto the selected exposed portions of the surface of the substrate.

### TECHNICAL FIELD

This invention relates to a method of forming an electrical circuit on the surface of a vehicle trim panel.

### BACKGROUND OF THE INVENTION

Vehicles typically have a number of trim panels mounted to different interior surfaces to present a pleasing appearance. One common type of trim panel is a door trim panel mounted to the interior surface of a door assembly. Typically, vehicle door assemblies include spaced apart inner and outer panels defining a cavity for mounting a window, window regulator, speaker, and other electrical devices. These devices are installed inside the door cavity through a plurality of access openings provided in the door inner panel.

The door trim panel conceals this interior surface of the door. The door trim panel is conventionally formed of a rigid panel, such as molded plastic or pressed hardboard, covered with a flexible decorative trim material such as cloth, vinyl, leather and/or carpeting. The door trim panel creates a pleasing appearance to the occupant, and is attached to the door by suitable fasteners.

The door trim panel also often supports a number of electrical components. These components include lights, window controls, rear view mirror controls, seat adjustment controls, and speakers. Each of these electrical components requires an individual wiring connector and power supply lead wires. The power supply lead wires for all the electrical components are typically bundled together to create what is commonly called a wiring harness. The wiring harness is often fixed to the trim panel or to the door to eliminate movement of the wires during operating conditions. As can be appreciated, the mounting and wiring of these electrical components is labor intensive and requires a number of connectors and other electrical parts.

Solutions to this problem have been contemplated by the prior art. Specifically, the prior art has proposed that the power supply lead wires be mounted, molded, etched, printed, or otherwise fixed to a separate rigid board. The rigid board is in turn mounted in some fashion to either the trim panel or the door or both. Hence, in these proposals, the door assembly includes the door itself, a rigid board, and then the trim panel. In another solution proposed by the prior art, the interior surface of the trim panel includes at least one groove interconnecting one electrical connector to another electrical connector. A binding agent and an electrically conductive material are integrally deposited and adhered to the groove to define an electrical circuit. In yet another solution a rigid template having openings for defining an electrical circuit trace is applied to the interior surface of the trim panel. The electrical circuit is then applied to the trim panel by spraying molten or powdered metal particles through the template openings and onto the interior surface of the trim panel.

These proposals, however, likewise have a number of deficiencies. The solution of incorporating the circuits into a separate board still requires a significant amount of manual labor to mount the wires to the board, mount the connectors to the board, and then mount the board itself to either the trim panel or the door. Further, additional connectors must be mounted on the board to electrically connect the connectors from the door to the connectors on the trim panel. The solution of a trim panel with an integrally molded electrical circuit requires a binding agent such as liquid polyurethane to be applied within the groove. This solution further requires specialized equipment and additional labor to apply the binding agent. The solution of applying an electrical circuit using a rigid template requires a unique template for each circuit trace pattern desired. The forming and changing of multiple rigid templates also requires additional equipment and labor.

Accordingly, it can be seen that it would be advantageous if there could be developed a method of forming an electrical circuit on a surface of a substrate.

It would also be advantageous if there could be developed a method of forming an electrical circuit on a surface of a substrate wherein the method uses a template or mask that is flexible.

It would also be advantageous if there could be developed a method of forming an electrical circuit on a surface of a substrate wherein the method uses a template or mask that is disposable.

It would additionally be advantageous if there could be developed a method of forming an electrical circuit on a surface of a substrate that uses a template or mask that includes an adhesive surface for adherence to the surface of the substrate.

It would also be advantageous if there could be developed a method of forming an electrical circuit on a surface of a substrate that is three-dimensional.

It would be further advantageous if there could be developed a method of forming an electrical circuit on a surface of a substrate including forming and applying a template or mask in a single manufacturing operation.

Further, it would be advantageous if there could be developed a method of forming an electrical circuit on a surface of a substrate wherein electrical circuit paths can be easily cut from the template or mask.

### SUMMARY OF THE INVENTION

The above objects as well as other objects not specifically enumerated are achieved by a method of forming an electrical circuit on a surface of a substrate. The method includes providing a substrate having a surface; placing a masking film against the surface of the substrate; subsequently removing portions of the masking film to expose selected portions of the surface of the substrate to define an electrical circuit path; and applying an electrically conductive material onto the selected exposed portions of the surface of the substrate.

In one embodiment of the invention, the masking film is made of polyethylene, and includes an adhesion resistant surface, and an opposite Surface having an adhesive layer. Preferably, the masking film is formed or shaped by a vacuum-forming tool having an outer surface formed of silicon rubber, and applied against the surface of the substrate with the vacuum-forming tool. Portions of the masking film are then cut be a laser to define an electrical circuit path, and the portions are removed to expose selected portions of the surface of the substrate. An electrically conductive material is thereafter applied to the selected exposed portions of the surface of the substrate to form an electrical circuit trace.

The subject invention also includes a polymeric masking film comprising an adhesive surface, and an adhesion resistant surface opposite the adhesive surface.

Various objects and advantages of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a trim panel assembly in spaced relationship to a vehicle door assembly;

FIG. 2 is a cross-sectional elevational view of a three-dimensional trim panel, and a disposable adhesive mask according to the invention.;

FIG. 3 is a cross-sectional elevational view of the trim panel of FIG. 2, and a vacuum-forming tool illustrating the disposable adhesive mask formed thereon;

FIG. 4 is a cross-sectional elevational view of the trim panel showing the application of the disposable adhesive mask to the trim panel;

FIG. 5 is a perspective view of the trim panel having the disposable adhesive mask applied thereon, illustrating the method of cutting an electrical circuit trace with a laser;

FIG. 6 is a cross-sectional elevational view of the trim panel showing the removal of a portion the disposable adhesive mask;

FIG. 7 is a cross-sectional elevational view of the trim panel illustrating the application of a liquid metallic spray;

FIG. 7A is an enlarged cross-sectional elevational view of the encircled portion of FIG. 7;

FIG. 8 is a cross-sectional elevational view of the trim panel showing the removal of the remaining portion of the disposable adhesive mask;

FIG. 9 is a cross-sectional elevational view of the vacuum-forming tool showing an alternative method of cutting the electrical circuit traces;

FIG. 10 is a cross-sectional elevational view of the trim panel, illustrating the application of a metallic powder spray; and

FIG. 10A is an enlarged cross-sectional elevational view of the encircled portion of FIG. 10.

### DETAILED DESCRIPTION OF THE INVENTION

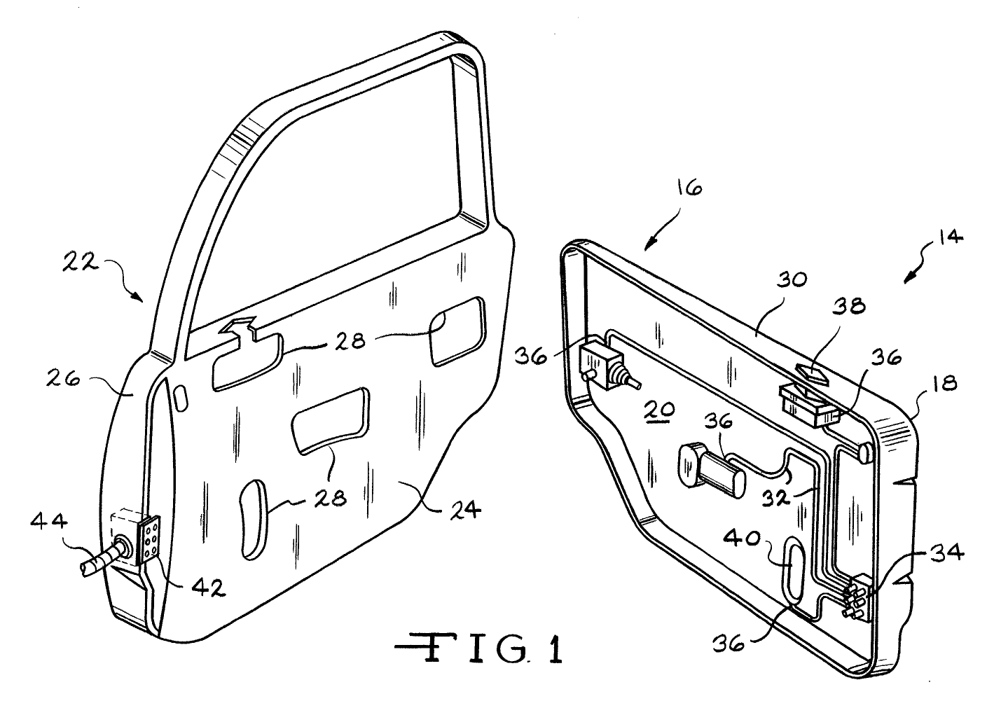

Referring now to the drawings, there is illustrated in FIG. 1 a vehicle trim panel assembly, generally shown at 14. The trim panel assembly 14 comprises the trim panel 16 of an electrically non-conductive material having an exterior surface 18 and a relatively smooth interior surface 20. The trim panel 16 of the preferred embodiment is an automotive door trim panel 16 which mounts to a vehicle door assembly, generally shown at 22. The trim panel 16 of the subject invention may be any type of trim panel associated with a vehicle. Other types of trim panels include trunk panels, quarter panels, rear package trays, headliners, instrument panels, garnish moldings, and console panels, among others.

The vehicle door assembly 22 includes spaced apart inner 24 and outer 26 metal panels defining a cavity (not numbered) for mounting a window, window regulator, speakers, and other electrical devices (all not shown). A plurality of access openings 28 are provided in the inner panel 24 to allow access into the cavity of the door assembly 22. The door trim panel 16 is used to conceal this interior surface 24 of the vehicle door 22.

The door trim panel 16 is preferably formed of a molded plastic material such as polypropylene. As appreciated by those skilled in the art, the trim panel 16 may be fabricated of wood fibers, polyurethane, solid molded vinyl, expanded polyurethane foam, any combination thereof, or any other suitable rigid, electrically non-conductive material. The exterior surface 18 of the trim panel 16 includes a decorative surface. Specifically, the trim panel 16 may be covered with a flexible decorative trim material 30 such as cloth, vinyl, leather, and/or carpeting. The trim panel 16 is attached to the vehicle door 22 by suitable fasteners (not shown) as is well known in the art.

The interior surface 20 of the trim panel 16 includes a metallic material 10, applied and adhered to the surface 20 of the trim panel 16 to define an electrical circuit. The electrical circuit comprises a plurality of spaced apart circuit traces 32. In the preferred embodiment, a first electrical connector 34 is placed at one end of each circuit trace 32. A second electrical connector 36 is placed at the other end of the same circuit trace 32. The electrical circuit trace 32 electrically connects the first electrical connector 34 to the second electrical connector 36. These electrical connectors 34, 36 can be of any suitable design or configuration without deviating from the scope of the invention. The interior surface 20 of the trim panel 16 also supports a number of electrical components. These components can include window controls (not shown), rear view mirror controls 38, seat adjustment controls (not shown), speakers 40, and the like. Each of these electrical components 38, 40 typically has an associated individual second electrical connector 36.

As shown in FIG. 1, the vehicle door assembly 22 also includes at least one electrical connector 42 that corresponds with the electrical connector 34 of the trim panel 16. A vehicle wiring harness 44 is coupled to the electrical connector 42 of the door assembly 22. Hence, the electrical connector 42 of the door assembly 22 is the main power supply source for all the components within the vehicle door 22 and the trim panel 16. Specifically, the first electrical connector 34 of the trim panel 16 is electrically connected to the electrical connector 42 of the door assembly 22 and the second electrical connector 36 of the trim panel 16 is electrically connected to one of the electrically operated components 38, 40.

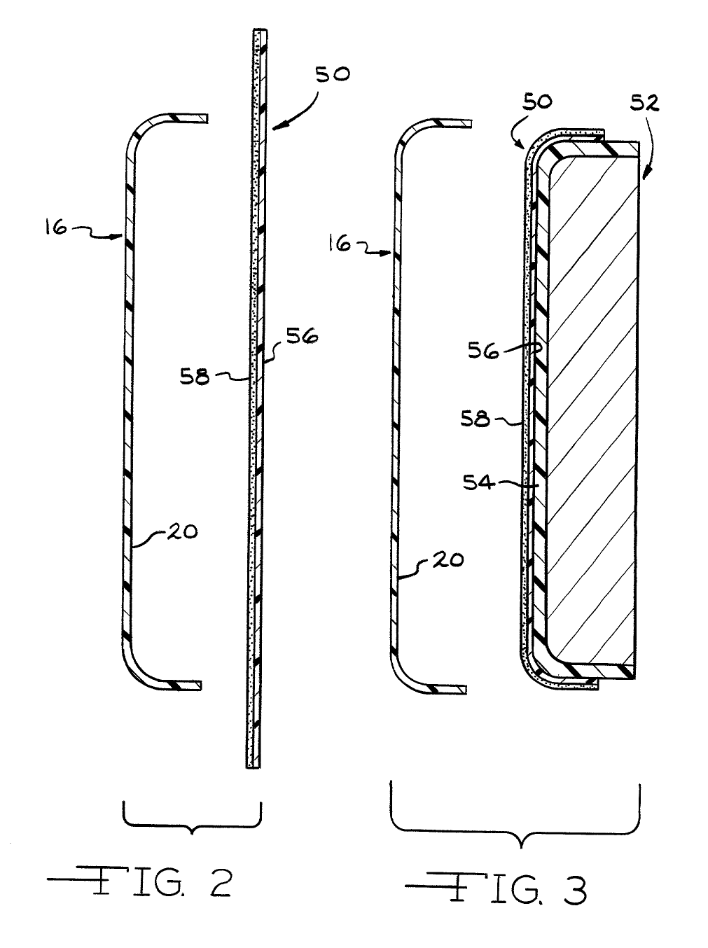

The method of the invention for forming an electrical circuit on the surface 20 of the vehicle trim panel 16 begins with placing a mask 50 against the interior surface 20 of the trim panel 16. Preferably, the mask 50 is adhesively applied to the interior surface 20 of the trim panel 16, but can be applied to the interior surface 20 by any suitable manner. The mask 50 is also preferably removable and disposable, the reason for which will be explained below. As shown in FIGS. 2 and 3, the disposable adhesive mask 50 is formed on a vacuum-forming tool 52. The vacuum-forming tool 52 includes an outer surface 54 configured to correspond to the interior surface 20 of the trim panel 16. The outer surface 54 of the vacuum forming tool 52 is preferably formed of an elastomeric material having a durometer hardness within the range of from about 35 to about 55, such as silicon rubber. The elastomeric material allows the outer surface 54 of the vacuum-forming tool 52 to conform to minor variations in the surface 20 that may occur during manufacture of the trim panel 16.

Preferably, the disposable adhesive mask 50 is a film such as a thin sheet of a polymer material, such as polyethylene or polypropylene, having an adhesion resistant first surface 56 and an adhesive layer 58 on a second surface. The adhesive layer 58 is preferably a heat activated adhesive and is caused to adhere to the surface 20 of the trim panel 16. The vacuum-forming tool 52 is configured to hold the first surface 56 of the mask 50 against the outer surface 54 of the tool 52. The vacuum-forming tool 52 operates by holding the mask 50 onto the tool 52 by suction supplied by a source of vacuum (not shown), and thereby causing the shape of the mask 50 to correspond to the shape of the tool 52. The operation of the vacuum tool to form or shape such a mask or film is well known in the art. However, in the preferred embodiment, the mask 50 is additionally held against the surface 54 of the tool 52 to facilitate movement of the mask 50 to the interior surface 20 of the trim panel 16, and for subsequent engagement of the mask 50 with the surface 20.

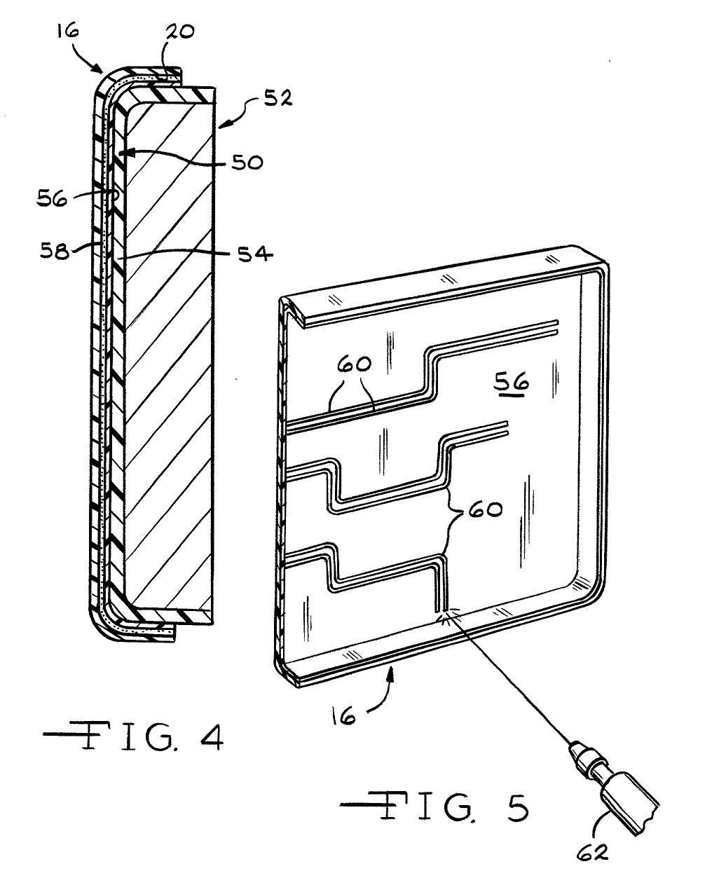

As illustrated in FIG. 4, a layer of the disposable adhesive mask 50 is applied on the surface 20 of the trim panel 16 by the vacuum-forming tool 52. This is accomplished by pressing the vacuum-forming tool 52 against the interior surface 20 of the trim panel 16. The adhesive layer 58 causes the mask 50 to adhere to the surface 20. The vacuum source can then be removed from the tool 52, thereby releasing the mask 50, and allowing the vacuum-forming tool 52 to be removed from the surface 20.

Although the illustrated disposable adhesive mask 50 is formed from a thin sheet of a polymer material, it is to be understood that the disposable adhesive mask 50 can also be a cured or an uncured liquid material (not shown). The liquid material can be applied to the outer surface 54 of the vacuum forming tool 52 by a spraying or dipping process (not shown) and thereafter cured to form a relatively solid material.

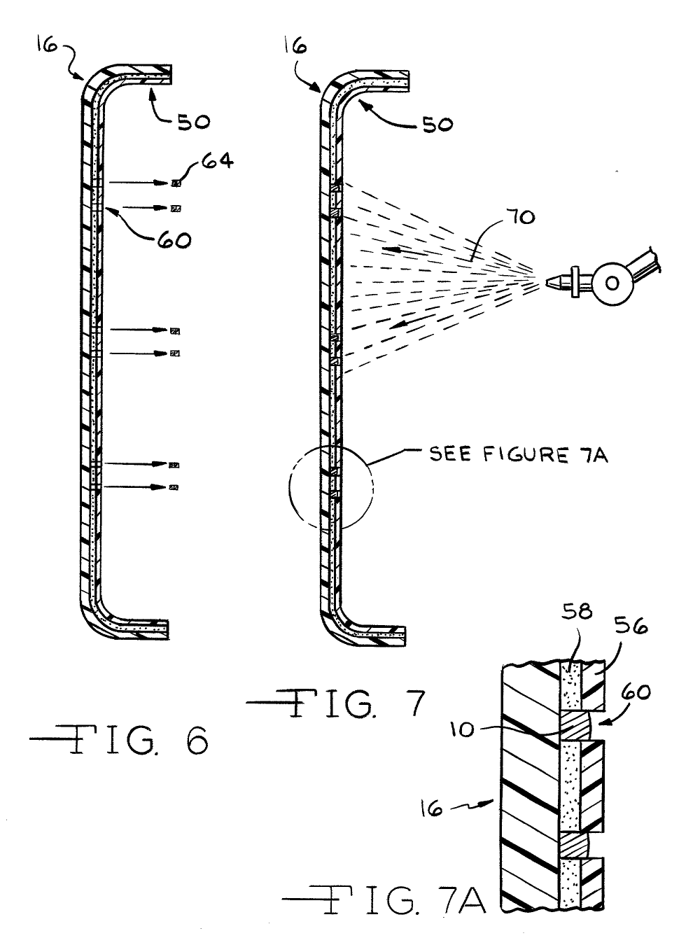

Outlines defining circuit paths 60 for the desired electrical circuits are then cut from the mask 50 by any one of several possible methods. For example, as illustrated in FIG. 5, a laser 62 can be used to cut away portions of the mask. As shown in FIG. 6, portions 64 of the mask 50 defining the electrical circuit paths 60 are then removed. After removing the portions 64, the remaining surface 20 of the trim panel 16 is still covered by the remainder of the mask 50, and the portions of the interior surface 20 of the trim panel 16 that are to receive the electrical circuit traces 32 are exposed.

In an alternative embodiment of the invention, as illustrated in FIG. 9, the circuit paths 60 defining the desired electrical circuits can be cut from the mask 50 by blades 66 incorporated into the elastomeric outer surface 80 of the vacuum-forming tool 82. The blades 66 are configured to correspond to the desired electrical circuit traces 32. Preferably, as shown in FIG. 9, the cutting edge of the blades 66 are located underneath the outer surface of the elastomeric outer surface 80. As the vacuum-forming tool 82 is pressed against the trim panel 16, the elastomeric outer surface 80 compresses to expose the cutting edges of the blades 66, thereby cutting the outline of the circuit paths 60 in the mask 50.

In yet another method of the invention, the outlines of the electrical circuit paths 60 can be pre-scored in the mask 50, and removed after the mask 50 is applied to the surface 20. Of course, the circuit paths 60 could also be cut by any suitable method after the mask 50 is applied to the surface 20.

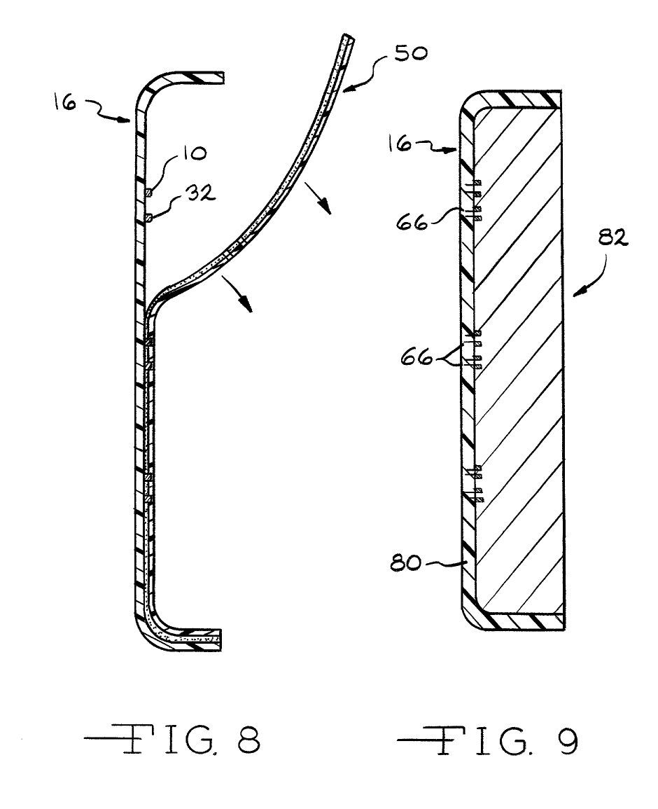

After the mask 50 has been applied to the trim panel 16, and portions 64 have been removed, an electrically conductive material is applied to the selected exposed portions of the surface 20 of the trim panel 16 corresponding to the desired traces 32. Preferably, the electrically conductive material is a metallic material 10 such as copper or zinc. Other types and combinations of metallic material may be used so long as the material has sufficient conductivity characteristics and will adhere to the surface 20 of the trim panel 16. For example, a single layer of zinc or copper may be used, or multiple layers of zinc and/or copper may be used. The metallic material 10 can be applied to the surface 20 by any suitable method, such as by spraying from a nozzle assembly, as shown in FIG. 7. For example, the metallic material 10 can be applied by spraying molten metal particles 70 directed at the trim panel 16, such as by a thermal spraying process or by plasma spraying. The adhesion resistant surface 56 of the mask 50 is purposely made to be a smooth and glossy surface unacceptable for adhesion of thermal sprayed or plasma sprayed metal so that the metallic material 10 will adhere only to the non-masked circuit paths 60 cut from the mask 50. Optionally, the remainder of the mask 50 can be then removed from the surface 20 as illustrated in FIG. 8.

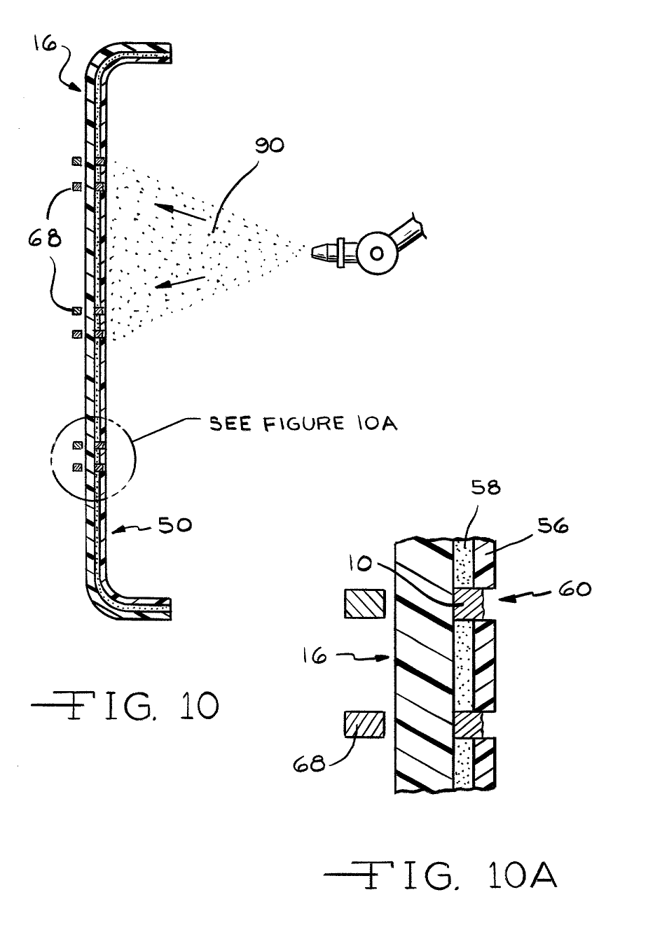

In an alternative method of applying the metallic layer, the metallic material 10 can be applied by high velocity kinetic deposit techniques, wherein metallic powder is directed towards the trim panel 16 by hot air, as shown in FIG. 10. Electrodes 68 can be positioned on the opposite side of the trim panel 16 adjacent the traces 32, and electrically charged via a high voltage source (not shown). A metallic powder spray 90 is then oppositely charged and caused to be attracted to the exposed paths on the surface 20 by electrostatic means. Preferably, the metallic material 10 is sprayed on at a very high velocity and the mask 50 is made of a material such that the metallic particles deflect or bounce off the mask 50 attached to the surface 20 of the trim panel 16. The over-spray can be collected and reprocessed for later spraying. In this case, the remaining portions of the mask 50 can be left on the surface 20 of the trim panel 16 since minimal metallic powder would adhere to the mask 50 and an undesired, electrical path would not be created. If desired, the mask 50 can be removed from the surface 20 after the metallic deposits 10 are applied to the exposed paths, as illustrated in FIG. 8.

The exposed paths on the surface 20 of the trim panel 16 provide a desirable surface, which retains the metallic material 10 during application of the material 10 by any of the aforementioned methods, and after the material 10 has cooled. While the smooth and glossy surface of the mask 50 is unacceptable for adhesion of thermal sprayed, plasma sprayed, or kinetic deposited metals, the selected exposed portions of the surface 20 are adapted to absorb and/or retain the metal particles.

The principle and mode of operation of this invention have been described in its preferred embodiments. However, it should be noted that this invention may be practiced otherwise than as specifically illustrated and described without departing from its scope.

What is claimed is:

1. A method of forming an electrical circuit on a surface of a substrate, the method comprising:
providing a substrate having a surface;
placing a masking film against the surface of the substrate;
subsequently removing portions of the masking film to expose selected portions of the surface of the substrate to define an electrical circuit path; and
applying an electrically conductive material onto the selected exposed portions of the surface of the substrate.

2. The method according to claim 1, including a masking film made of a polymer material.

3. The method according to claim 1, including a masking film made of a polyethylene.

4. The method according to claim 1, wherein the masking film includes an adhesive for adherence to the substrate.

5. The method according to claim 1, wherein the masking film includes an adhesion resistant first surface, and a second surface having an adhesive layer for adherence to the substrate.

6. The method according to claim 5, including an adhesive layer which is heat activated.

7. The method according to claim 1, wherein subsequent to applying the electrically conductive material onto the selected exposed portions of the surface of the substrate, at least a portion of the remaining masking film is removed from the substrate.

8. The method according to claim 1, wherein subsequent to applying the electrically conductive material onto the selected exposed portions of the surface of the substrate, all of the remaining film is removed.

9. The method according to claim 1 including placing the masking film against the surface of the substrate with a vacuum-forming tool, the vacuum-forming tool having an outer surface formed of an elastomeric material.

10. The method according to claim 1, wherein subsequent to placing the masking film against the surface of the substrate, portions of the masking film are cut by a laser to define the electrical circuit path.

11. The method according to claim 1, wherein subsequent to placing the masking film against the surface of the substrate, portions of the masking film are cut by blades to define the electrical circuit path.

12. The method according to claim 9, wherein subsequent to placing the masking film against the surface of the substrate, portions of the masking film are cut by blades located beneath an outer surface of the elastomeric material of the vacuum-forming tool to define the electrical circuit path.

13. The method according to claim 1, wherein prior to placing the masking film against the surface of the substrate, the masking film is scored to define the electrical circuit path.

14. The method according to claim 1, wherein the substrate is a vehicle trim panel having an interior surface, and an exterior surface with a decorative appearance.

15. A method of forming an electrical circuit on a surface of a vehicle trim panel, the method comprising:
providing a trim panel having an interior surface, and an exterior surface;
placing a masking film on a vacuum forming tool;
placing the masking film against the interior surface of the trim panel;
subsequently removing portions of the masking film to expose selected portions of the interior surface of the trim panel to define an electrical circuit path; and
applying an electrically conductive material onto the selected exposed portions of the interior surface of the trim panel, the electrically conductive material forming an electrical circuit trace.

16. The method according to claim 15, wherein subsequent to applying the electrically conductive material onto the selected exposed portions of the interior surface of the trim panel, at least a portion of the remaining masking film is removed from the trim panel.

17. The method according to claim 15, wherein subsequent to applying the electrically conductive material onto the selected exposed portions of the interior surface of the trim panel, all of the remaining film is removed.

18. The method according to claim 15, wherein subsequent to placing the masking film against the interior surface of the trim panel, portions of the masking film are cut by a laser to define the electrical circuit path.

19. The method according to claim 15, wherein subsequent to placing the masking film against the surface of the trim panel, portions of the masking film are cut by blades to define the electrical circuit path.

20. The method according to claim 19, wherein the blades are contained within the vacuum-forming tool.

21. The method according to claim 15, wherein prior to placing the masking film against the interior surface of the trim panel, the masking film is scored to define the electrical circuit trace.

22. The method according to claim 15, wherein the masking film includes an adhesive for adherence to the substrate.

23. A method of forming an electrical circuit on a surface of a vehicle trim panel, the method comprising:
providing a trim panel having an interior surface, and an exterior surface with a decorative appearance;
placing a masking film on a vacuum forming tool, the masking film including an adhesion resistant first surface, and a second surface having an adhesive layer for adherence to the interior surface of the trim panel, and the vacuum-forming tool having an outer surface formed of an elastomeric material;
placing the masking film against the interior surface of the trim panel;
subsequently removing portions of the masking film to expose selected portions of the interior surface of the trim panel to define an electrical circuit path;
applying an electrically conductive material onto the selected exposed portions of the interior surface of the trim panel, the electrically conductive material forming an electrical circuit trace; and
subsequently removing all of the remaining portions of the masking film.

24. A polymeric masking film for forming an electrical circuit on a surface of a substrate comprising:
an adhesive surface; and
an adhesion resistant surface opposite said adhesive surface.

25. The masking film according to claim 24, wherein said adhesive surface is heat activated.

26. The masking film according to claim 24, wherein said masking film is made of polyethylene.
